(19) United States
(12) Patent Application Publication
(10) Pub. No.: US 2004/0118026 A1
(43) Pub. Date: Jun. 24, 2004

(54) Side-beam reflecting billboard structure

(76) Inventor: Wen-Chun Yeh, Taipei Hsien (TW)

Correspondence Address: Mini Angel Advertising Co., Ltd., P.O. Box No. 6-57, Chung-Ho, Taipei, 235, TW

(21) Appl. No.: 10/326,385

(22) Filed: Dec. 23, 2002

(51) Int. Cl. G09F 13/00

(52) U.S. Cl. 40/547

(57) ABSTRACT

An amelioration of a side-beam reflecting billboard structure includes a solid transparent acrylic board of an appropriate thickness having at least one light source at one of the sides thereof and at least one text-and-graphic surface at the front side thereof; and the characteristics of the invention are that at least one reflecting board applied with guiding ink is provided within the interior of the acrylic board and the reflecting board crisscrosses with the traveling direction of the light beams from the light source to the acrylic board, so that the light beams are thoroughly reflected on the guiding ink of reflecting board.

### BACKGROUND OF THE INVENTION

(a) Field of the Invention

The present invention provides an amelioration of a side-beam reflecting billboard structure that, in principle, is provided with an inclining reflecting board within an acrylic board of the billboard thereof. The reflecting board is provided with guiding ink for bright reflection effects, and is not easily damaged as being covered within the interior of the acrylic board. In addition, the reflecting board crisscrosses with the traveling direction of light beams for obtaining good reflection effects, thereby making the light beams on the billboard more evenly distributed and radiant as the main feature of the invention.

(b) Description of the Related Art

For structures of popular billboards in use today, light sources are provided at one side of the billboards, where light beams are projected onto the main part of the advertisement thereof (texts, graphics, or three-dimensional designs) through refraction or reflection. Such light beams are toned down and do not dazzle the eye at nighttime, as well as being readily to create pleasant atmosphere. Modern billboards may be utilized in advertisement signboards, indicator light signs and three-dimensional illuminating sign cases. Referring to FIGS. 5 and 6, the structure of a modern billboard comprises a solid transparent acrylic board of an appropriate thickness 60 having a layer of guiding ink 70 applied to the back side thereof, and the other side of the acrylic 70 is printed with a text-and-graphic surface 80. The acrylic board 60 is further provided with a light source 51 composed of thin light tubes and a cover. Light beams from the light source 51, after entering the acrylic board 60, illuminate the guiding ink 70 and form a silvery back-screen through reflection and diffusion therein, thus the text-and-graphic surface 80 is enhanced by the bright background, giving a glistening appearance.

However, the drawback of the prior structure is that, because the guiding ink 70 is directly applied to the back side of the acrylic board 60, it is then easily scratched and damaged by handling or involuntary contact, thereby reducing the brightness of the background being reflected by the light beams.

In addition, since that the light source 51 is provided at the side of the acrylic board 60, where the light beams enter the interior perpendicularly and travel along the plane of the guiding ink 70, the diffused and reflected light beams then strike on the guiding ink 70 forming lightspots which are hardly considered as very bright. By increasing the intensity of the light beams not only wastes a considerable amount of electricity but also affects the lifetime of the light bulbs in the light source 51, and this adds another drawback to the prior structure.

### SUMMARY OF THE INVENTION

Therefore, an object of the invention is to provide a better brightness intensity and make the invention less damageable by directly providing an inclining board and accompanying guiding ink within the interior of an acrylic board, so that incoming light beams from the sides are effectively reflected, being a distinguishing feature of the invention.

To achieve the above object, the present invention is accomplished by the method below. A solid transparent acrylic board of an appropriate thickness is provided. At least one light source is provided at one side of the acrylic board and at least one text-and-graphic surface is further provided at the front side of the acrylic board. The feature of the invention is that, a reflecting board applied with a layer of guiding ink is embedded in the interior of the acrylic board, and hence the guiding ink is not easily damaged. In addition, the reflecting board crisscrosses with the traveling direction of the incoming light beams from the light source, and therefore the light beams are thoroughly reflected at the guiding ink of the reflecting board, thereby making the light beams of the billboard more evenly distributed and radiant.

### BRIEF DESCRIPTION OF THE DRAWINGS

FIG. 1 is a perspective view showing the structure according to the invention.

FIG. 2A is a top cross-sectional view according to the invention.

FIG. 2B is top a cross-sectional view illustrating the embodiment of double-side reflection according the invention.

FIG. 3 is a schematic view illustrating the first embodiment of the invention.

FIG. 4 is a top cross-sectional view illustrating the first embodiment according to the invention.

FIG. 5 is a schematic view illustrating the second embodiment according to the invention.

FIG. 6 is a conventional schematic view illustrating a prior structure.

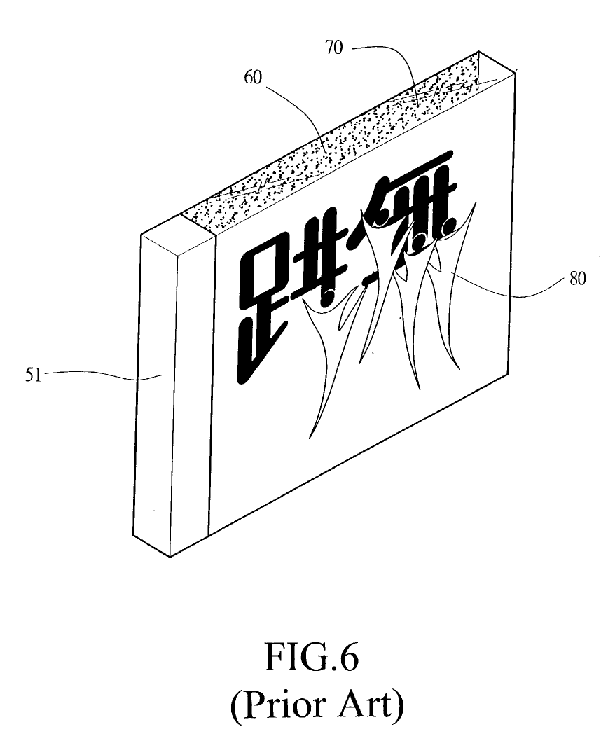

FIG. 7 is a conventional top cross-sectional view illustrating a prior structure.

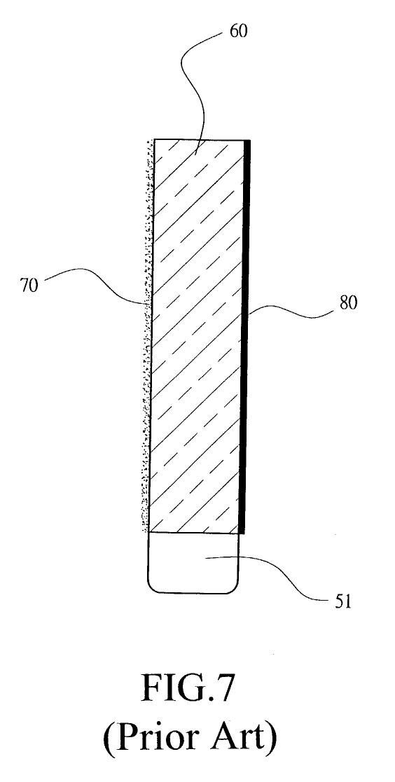

### DESCRIPTION OF THE PREFERRED EMBODIMENTS

To better understand the content of the invention, detailed descriptions shall be given with the accompanying drawings.

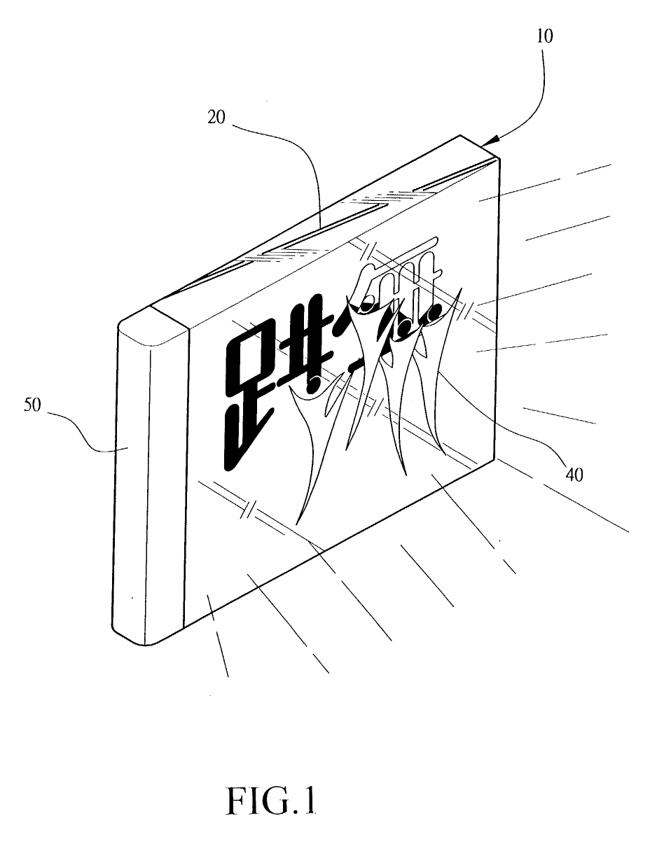

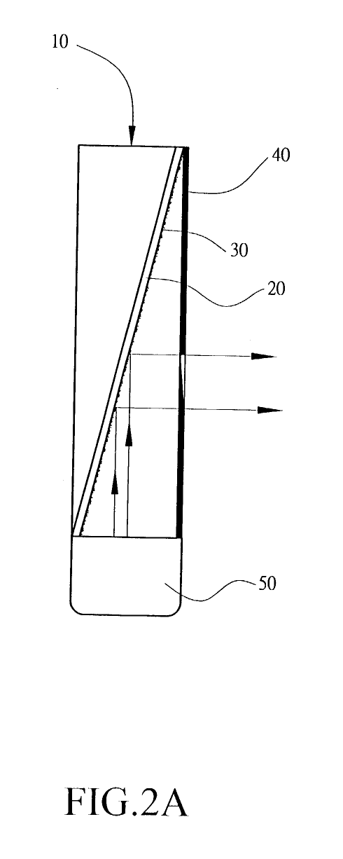

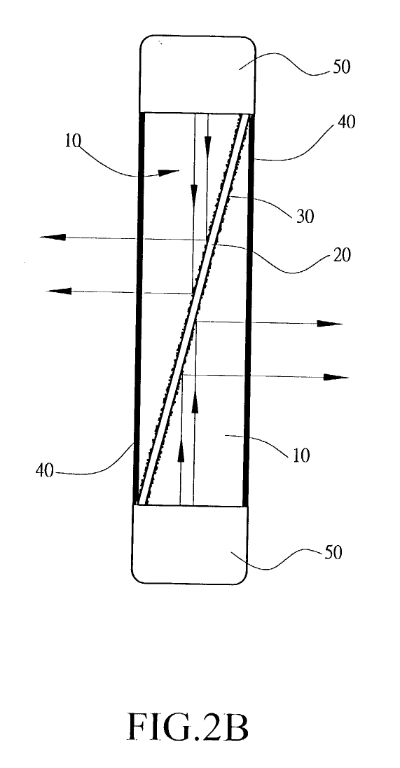

Referring to FIGS. 1 and 2A, in accordance with the invention, at least one solid transparent acrylic board 10 is provided. The acrylic board 10 is further provided with at least one graphic-and-text surface 40 at one of the front and back sides thereof and at least one light source 50 at one of the right and left sides thereof as well.

A reflecting board 20 is arranged in an inclining angle within the interior of the acrylic board 10, and is applied with a layer of guiding ink 30 to at least one of the sides thereof. The incoming light beams from the light source 50 to the interior of the acrylic board 10 travel linearly; most are able to directly collide into the reflecting board 20 set up in an inclining angle to the traveling direction of the light beams and then reflect outwards, thus increasing the light intensity of the guiding ink 30.

Referring to FIG. 2B, the acrylic board 10 is provided with a graphic-and-text surface 40 at both the front and back sides thereof, respectively, whereas the reflecting board 20 is also provided with guiding ink 30 at both of the sides thereof. A light source 50 is further provided at both right and left sides of the acrylic board 10, respectively, so that the respective light beams are reflected by the reflecting board 20 and projected outwards to the front and back sides of the acrylic board 10, and therefore the front and back sides of the acrylic board 10 may be utilized simultaneously.

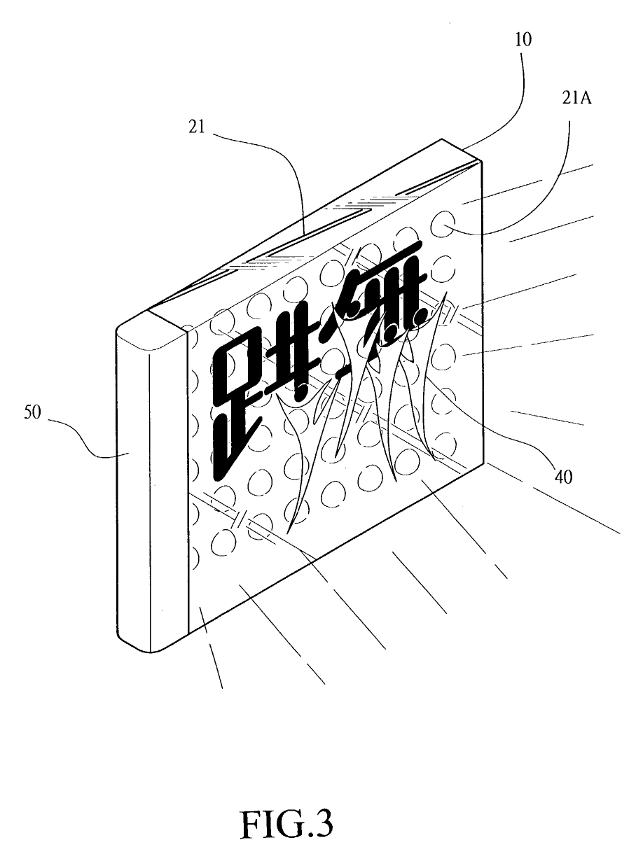

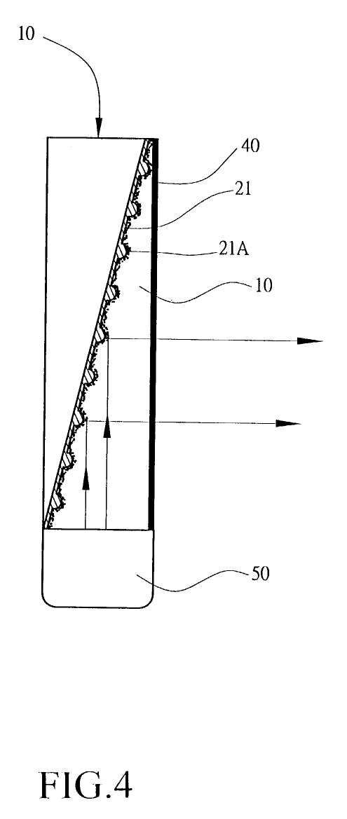

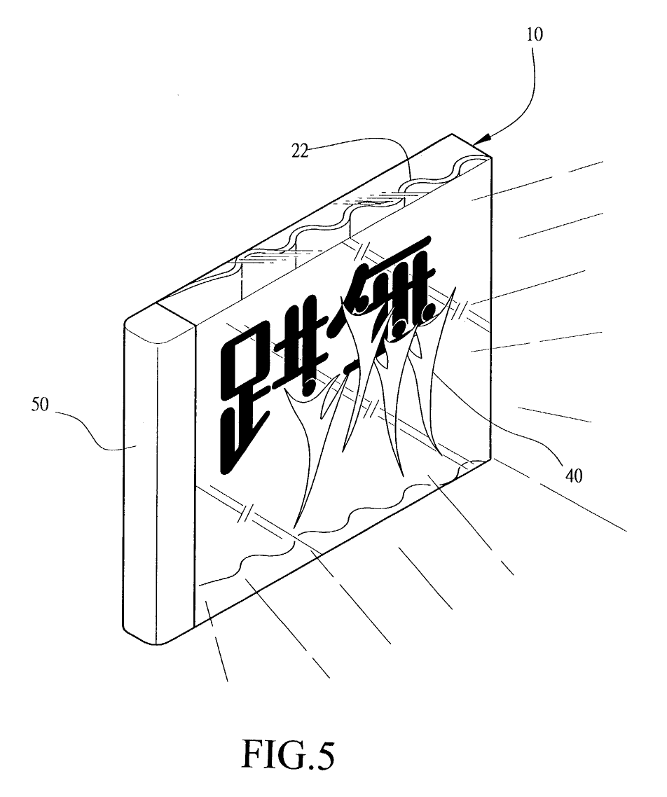

Referring to FIGS. 3 and 4, another embodiment according to the invention, a reflecting board 21 provided with a plurality of light-condensing bumps 21A is placed within the interior of the acrylic board 10, so that light beams are condensed to obtain different reflection and light-condensation effects. Moreover, referring to FIG. 5, another embodiment according to the invention, a reflecting board 22 in a corrugated structure is provided such that light beams projected onto the corrugated reflecting board 22 demonstrate a repeated reflection effect within the acrylic board 10, thus increasing the diffusion effect and making the light beams more lambent.

The aforesaid reflecting boards 20, 21 and 22 are placed into the acrylic board 10 by arranging the reflecting board 20 into the mold of the acrylic board 10 before casting the acrylic board 10. The acrylic raw material is then added to seal the reflecting board 20 within the acrylic board 10.

Based on the ingenuity of the invention, the invention has the following excellences in usage:

1. In accordance with the invention, an inclining reflecting board applied with a layer of guiding ink is provided within the interior of the transparent acrylic board, and so the incoming light beams from the light source at the side to the interior of the acrylic board are able to directly collide into the reflecting board 20 set up in an inclining angle to the traveling direction of the light beams and then reflect outwards, thus increasing the light intensity of the guiding ink.

2. For that the reflecting board applied with the guiding ink is embedded in the interior of the acrylic board, the guiding ink is then not easily scratched or damaged, thereby prolonging the lifetime thereof.

3. The reflecting board applied with the guiding ink may be light-condensing bumps or a corrugated structure for projecting the light beams, and therefore the light-condensation and reflection effects are elevated.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A side-beam reflecting billboard structure comprising a solid transparent acrylic board of an appropriate thickness having at least a light source at one of the sides thereof and at least a text-and-graphic surface at the front side thereof; and the characteristics of the invention are:
at least one reflecting board applied with a layer of guiding ink is provided within the interior of the acrylic board, and the reflecting board crisscrosses with the traveling direction of the incoming light beams from the light source to the interior of the acrylic board.

2. The side-beam reflecting billboard structure in accordance with claim 1, wherein the reflecting board is provided with a plurality of light-condensing bumps.

3. The side-beam reflecting billboard structure in accordance with claim 1, wherein the reflecting board is a corrugated structure.

4. The side-beam reflecting billboard structure in accordance with claim 1, wherein the acrylic board is provided with a text-and-graphic surface at the front and back sides thereof, respectively, and guiding ink is provided at both sides of the reflecting board and a light source at the sides of the acrylic board, respectively, so that the two light sources project light beams towards one side of the reflecting board, respectively, to reflect as backlight of the text-and-graphic surfaces, thereby simultaneously utilizing the front and back sides of the acrylic board.
